(19) United States
(12) Patent Application Publication
(10) Pub. No.: US 2026/0009165 A1
(43) Pub. Date: Jan. 8, 2026

(54) CARBON-BASED ENERGY STORAGE DEVICES, METHODS, AND APPARATUSES

(71) Applicant: CARBON HOLDINGS INTELLECTUAL PROPERTIES, LLC, Ranchester, WY (US)

(72) Inventors: Charles Agee Atkins, Sheridan, WY (US); Charles S. Hill, Sheridan, WY (US)

(21) Appl. No.: 19/262,913

(22) Filed: Jul. 8, 2025

Related U.S. Application Data
(60) Provisional application No. 63/668,692, filed on Jul. 8, 2024.

(51) Int. Cl. D01F 9/15; C01B 32/198

(52) U.S. Cl. CPC D01F 9/15; C01B 32/198; C01P 2004/01; C01P 2006/40; C01P 2006/80

(57) ABSTRACT

Carbon-based energy storage devices and methods of forming the same are disclosed. A method of producing an energy storage device can include treating pitch to produce a carbon fiber material, fusing a plurality of carbon fibers of the carbon fiber material together to form a carbon monolith, such that the plurality of carbon fibers are fused at contact points by melt blowing, and compressing the carbon monolith to a predetermined density.

### CROSS-REFERENCE TO RELATED APPLICATIONS

This application claims priority to U.S. Provisional Patent Application No. 63/668,692 filed 8 Jul. 2024 and entitled “Methods and Apparatus for Production of Supercapacitors Using Graphite from Coal,” the disclosure of which is hereby incorporated by reference in its entirety.

### FIELD

The described embodiments relate generally to carbon based processing methods. More particularly, the present embodiments relate to systems and methods for processing hydrocarbon coal to make advanced carbon materials including energy storage devices, such as, for example supercapacitors, batteries, and fuel cells.

### BACKGROUND

Coal has been mined and used for a variety of purposes for thousands of years. Since the industrial revolution, the primary use for coal has been to generate heat and energy to power homes, industry, and transportation. Coal initially found widespread use as a transportation fuel for trains during the industrial revolution, but the advent of cars and the discovery of large petroleum deposits near the turn of the twentieth century precipitated a shift towards the primacy of liquid, petroleum-based fuels for transportation.

Research on coal continued, however, and the basic chemistry of coal was well understood by at least the early twentieth century. Although significant research has been conducted on coal for more than a century, this extensive prior work has overwhelmingly been focused on the development of transportation fuels. The use of coal to produce other materials of greater industrial relevance has yet to be fully explored. For example, coal and coal preparation products can be made into graphite, graphene, and hard carbons, which can then be used to make advanced carbon materials including energy storage devices, such as, for example, supercapacitors, batteries, and fuel cells.

Supercapacitors are a type of an electrochemical energy storage system which has great power density and specific capacitance. These systems can efficiently release energy with a high density over a relatively short time. Depending on their operating principle, supercapacitors are mainly categorized into two types, which include pseudocapacitance and electric double-layer capacitance. Carbon-based materials can effectively be employed as supercapacitor electrode materials. Among these materials, graphene exhibits excellent energy transfer features, and it has proven to be an efficient electrode material for supercapacitors.

### SUMMARY

An aspect of the present disclosure relates to a method of producing an energy storage device. The method can include treating pitch to produce a carbon fiber material, fusing a plurality of carbon fibers of the carbon fiber material together to form a carbon monolith, and compressing the carbon monolith to a predetermined density. The plurality of carbon fibers can be fused at contact points by melt blowing.

In some examples, the method can further include beneficiating coal including impurity atoms to remove a predetermined amount of the impurity atoms and processing the beneficiated coal to produce the pitch. In some examples, the coal can include impurity atoms. The impurity atoms can include at least one of cadmium, selenium, boron, nitrogen, or silicon.

In some examples, the pitch can include mesophase pitch. In some examples, the compressed carbon monolith can have a specific surface area in a range from 5 m²/g to 3000 m²/g.

In some examples, the method can further include manufacturing an energy storage device using the compressed carbon fiber monolith in a roll-to-roll process.

In some examples, the carbon monolith can include impurity atoms including at least one of cadmium, selenium, boron, nitrogen, or silicon. In some examples, a concentration of the impurity atoms in the carbon monolith can be in a range from 0.1 atomic % to 10 atomic %.

Another aspect of the present disclosure relates to an energy storage device formed from coal. The energy storage device can include an electrode including a first activated carbon fiber monolith and a second activated carbon fiber monolith compressed with the first activated carbon fiber monolith. The electrode can exhibit predetermined performance characteristics.

In some examples, the predetermined performance characteristics can include at least one of specific capacitance, volumetric capacitance, power level, or current density. In some examples, the first activated carbon monolith can have a porosity or density different from the second activated carbon monolith.

Yet another aspect of the present disclosure relates to a method of producing a carbon-based energy storage device from coal. The method can include thermally processing coal at a temperature of at least 300° F., at least partially cooling the coal, forming a reduced graphene oxide from the coal, and forming an energy storage device from the reduced graphene oxide.

In some examples, forming the reduced graphene oxide from the coal can include oxidizing the coal to form a coal oxide, centrifuging the coal oxide, collecting a precipitate from the coal oxide, the precipitate including graphene oxide, and reducing the graphene oxide to form the reduced graphene oxide. In some examples, oxidizing the coal to form the coal oxide can include mixing the coal with at least one of sulfuric acid, nitric acid, or potassium permanganate, or hydrogen peroxide to form the coal oxide.

In some examples, mixing the coal with at least one of sulfuric acid, nitric acid, potassium permanganate, or hydrogen peroxide to form the coal oxide can include mixing the coal with at least one of sulfuric acid or nitric acid to form a first coal mixture, stirring the first coal mixture, mixing potassium permanganate with the first coal mixture to form a second coal mixture, stirring the second coal mixture, diluting the second coal mixture with water to form a first solution, mixing the solution with hydrogen peroxide to form a second solution, performing a first centrifugation on the second solution, and separating a supernatant of the second solution from a precipitate of the second solution after performing the first centrifugation. The supernatant can include the coal oxide.

In some examples, the method can further include diluting the coal oxide with water before centrifuging the coal oxide. In some examples, reducing the graphene oxide to form reduced graphene oxide can include sonicating the graphene oxide; and hydrothermally treating the graphene oxide in a par reactor after sonicating the graphene oxide.

In some examples, the thermally processing the coal at the temperature of at least about 300° F. can include heating the coal to a first temperature of less than 350° F., transferring the coal to a mercury removal reactor, heating the coal in the mercury removal reactor to a second temperature of at least 500° F., and contacting the coal with an inert gas to remove at least a portion of mercury present in the coal.

In some examples, the reduced graphene oxide can include a predetermined amount of impurity atoms present in the coal. In some examples, the impurity atoms can include at least one of boron, nitrogen, or silicon.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a block diagram of a method of forming carbon products.

FIG. 2 illustrates a block diagram of a method of forming carbon products.

FIG. 3A illustrates an electron microscope image of a carbon material.

FIG. 3B illustrates an electron microscope image of a carbon material.

FIG. 3C illustrates an electron microscope image of a carbon material.

FIG. 3D illustrates an electron microscope image of a carbon material.

FIG. 4 illustrates a schematic view of an energy storage device.

FIG. 5 illustrates a flow diagram of a method of forming carbon products.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

As described below, one of the main reasons which makes graphene an appropriate electrode material in supercapacitors is its large specific surface area that is related to the layered nanostructure of the graphene. Functionalization of graphene can also be effectively applied to tune the electrochemical features of the electrode in supercapacitors. Through variations in the thermal reduction of graphite oxide, various functional groups including oxygen-bearing groups exist on the material surface can be changed that lead to different specific capacitance.

The following disclosure relates to methods of forming and functionalizing carbon products. The carbon products can be used in a number of applications, including as components of energy storage devices, such as, for example, supercapacitors, batteries, and fuel cells. The carbon products can include, for example, graphite, graphene, and hard carbons. The carbon products can be formed with low electrical resistance (and high electrical conductivity), which can be beneficial in energy storage applications. The carbon products can be formed with controlled thicknesses, and porosities, including with gradient porosities, which can be advantageous in various electrical applications. The carbon products can be formed as rolls with controlled thicknesses. The rolls can be used to manufacture products, such as energy storage devices, with reduced costs, simplified processing steps, and increased throughput. The carbon products can be formed from coal, pitch, or other raw materials.

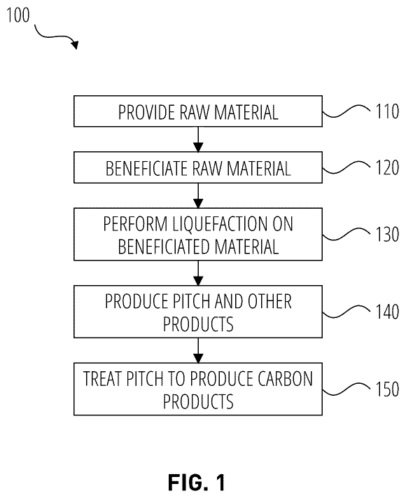

These and other examples are discussed below with reference to FIGS. 1 through 5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a block diagram of a method 100 of forming carbon products from coal. As examples, the method 100 can be used to form graphite, graphene, hard carbons, or the like. The method 100 can include a block 110 in which a raw material is provided; a block 120 in which the raw material is beneficiated; a block 130 in which a liquefaction process is performed on the beneficiated material; a block 140 in which pitch and other products are formed from the beneficiated material; and a block 150 in which the pitch is treated to produce carbon products. In some examples, the method 100 can include additional blocks or blocks of the method 100 can be omitted. For example, the method 100 illustrated in FIG. 1 can begin with coal as a raw material. In some examples, the method 100 can begin with pitch as a raw material and blocks 120, 130, and 140 can be omitted.

According to some embodiments, and as illustrated in FIG. 1, synthetic graphene can be produced from coal by a method or process 100 including providing coal to a processing facility at block 110; beneficiating the coal via the processing facility at block 120 to remove a desired amount of water, mercury, cadmium, selenium, other heavy metals, boron, nitrogen, silicon, and/or other impurities (e.g., impurity atoms) from the coal; processing at least some of the beneficiated coal via the processing facility at block 130; producing pitch, char, gases, and/or coal liquid extract at block 140; and treating at least one of the pitch, char, gases, and coal liquid extract via the processing facility at block 150 to produce synthetic graphite. In some examples, block 150 can further include treating the synthetic graphite via the processing facility to produce synthetic graphene.

As described herein, a desired amount of one or more impurities (e.g., impurity atoms) can remain in the beneficiated coal at block 120 and can thereby be incorporated into the synthetic graphene produced at block 150 in order to adjust the chemical, electrical, and/or physical properties of the synthetic graphene.

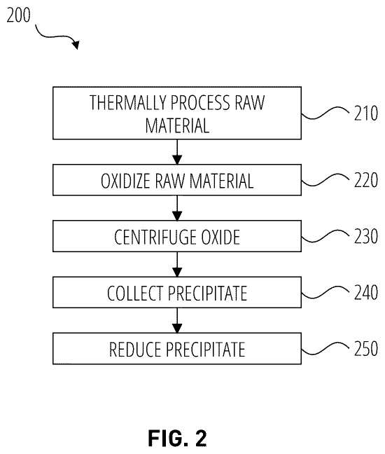

FIG. 2 illustrates a block diagram of a method 200 of forming carbon products from coal. As examples, the method 200 can be used to form graphite, graphene, hard carbons, or the like. The method 200 can include a block 210 in which a raw material is thermally processed; a block 220 in which the raw material is oxidized; a block 230 in which the oxide is centrifuged; a block 240 in which a precipitate from of the oxide is collected; and a block 250 in which the precipitate is reduced. In some examples, the method 200 can include additional blocks or blocks of the method 200 can be omitted.

According to some embodiments, and as illustrated in FIG. 2, graphene or graphite can be produced from coal by a method or process 200. The method 200 can include thermally processing the coal at block 210 and forming reduced graphene oxide from the coal after the coal has been at least partially cooled from the thermal processing. Forming the reduced graphene oxide from the coal can include: oxidizing the coal at block 220 to form coal oxide; centrifuging the coal oxide at block 230; collecting precipitate from the coal oxide after centrifuging at block 240, the precipitate including graphene oxide; and reducing the graphene oxide at block 250 to produce reduced graphene oxide. In some examples, other activities can be used to form graphene from the thermally-treated coal, such as chemical vapor deposition or formation of carbon dots.

Although the method 200 has been described in the context of a process flow for producing graphene, the method 200 can be used to produce more than one type of carbon material. For example, the method 200 can be used to form carbon products, such as, for example, graphite, graphene, and hard carbons. The method 200 can be used to form carbon products having desirable characteristics for use in electrical applications, such as energy storage devices. The method 200 can be used to form carbon products that have desired thicknesses, porosities, densities, pore sizes, binding sites, electrical conductivities, electrical resistances, and the like. In some examples, the method 200 can be used to form carbon products that have gradient densities, such as densities that vary in a gradient between opposite surfaces of the carbon product. In some examples, functionalization or densities of the carbon products can vary through the thickness of the carbon product, which can drive ionic conductivity and specificity of complexed metal ions. The complexed metal ions can be complexed in the carbon product as functionalization chemistry. The variation of functionalization or densities of the carbon products through the thickness of the carbon product, can optimize mass transport and electrical conductivity of the carbon products. Further, various steps of the method 200 can each include multiple steps, and various steps of method 200 may not be a separate process steps in and of themselves.

The coal that is thermally processed at block 210 can include raw coal, as described in greater detail above, or coal that is at least partially processed. The raw or at least partially processed coal can include coal crushed to a suitable or predetermined size. Thermally processing the coal can include beneficiating the coal to remove contaminants or impurities (e.g., impurity atoms), as described above in greater detail.

The thermal processing of block 210 can include thermally processing coal at a temperature of at least about 300° F. In some examples, the thermal processing of block 210 can include heating coal to a first temperature not to exceed 350° F., transferring the coal to a mercury removal reactor, heating the coal in the mercury removal reactor to a second temperature of at least 500° F., and contacting the coal with an inert gas to remove at least a portion of mercury present in the coal.

In some examples, heating the coal to a first temperature in block 210 not to exceed 350 OF includes heating the coal to the first temperature not to exceed, for example, between about 250° F. and about 350° F., between about 275° F. and about 325° F., between about 285° F. and about 315° F., between about 295° F. and about 305° F., between about 295° F. and about 300° F., between about 300° F. and about 305° F., about 290° F., about 295° F., about 300° F., about 301° F., about 302° F., about 303° F., about 304° F., about 305° F., about 310° F., about 315° F., about 320° F., about 325° F., about 330° F., about 335° F., about 340° F., about 345° F., or about 350° F. When the coal is heated to the first temperature, free water and at least a portion of bound water in the coal is vaporized and removed in a sweep gas. In some examples, the coal can be heated in a moisture removal reactor and/or a vibrating fluidized-bed system. Dryer auxiliaries in the moisture removal reactor can include a hot gas generator, a coal feeder, and valves.

After heating the coal to the first temperature, the coal can be transferred to a mercury removal reactor, where the coal can be heated to a second temperature in block 210 of at least 500° F. In some embodiments, the coal can be heated in the mercury removal reactor to the second temperature of, for example, between about 400° F. and about 700° F., between about 450° F. and about 650° F., between about 500° F. and about 600° F., between about 525° F. and about 575° F., between about 535° F. and about 570° F., between about 540° F. and about 565° F., between about 545° F. and about 560° F., between about 550° F. and about 555° F., at least about 500° F., at least about 510° F., at least about 520° F., at least about 530° F., at least about 540° F., at least about 545° F., at least about 550° F., at least about 555° F., about 550° F., about 551° F., about 552° F., about 553° F., about 554° F., about 555° F., about 556° F., about 557° F., about 558° F., about 559° F., or about 560° F.

A down-flow reactor can be used to expose the coal to a hot inert gas, which volatizes and removes at least a portion of the mercury and/or at least a portion of one or more dopants. For example, between about 70% and about 80% of the mercury in the coal can be volatized and removed from the coal. In some cases, other dopants or impurities (e.g., impurity atoms) can be removed from the coal, for example, cadmium, selenium, boron, nitrogen, silicon, and/or any other element except carbon which may be present in the coal. The coal also can be cooled to a third temperature in the mercury removal reactor. The third temperature can be, for example, below about 400° F., below about 375° F., below about 350° F., below about 325° F., below about 300° F., below about 275° F., or below about 250° F. Upon cooling to the third temperature, the coal can be reduced in size before forming reduced graphene oxide from the coal.

As noted above, forming reduced graphene oxide from the coal can include: oxidizing the coal at block 220 to form coal oxide; centrifuging the coal oxide at block 230; collecting precipitate from the coal oxide after centrifuging at block 240, the precipitate including graphene oxide; and reducing the graphene oxide at block 250 to produce reduced graphene oxide. At block 220, oxidizing the coal to form a coal oxide can include mixing the coal with at least one of sulfuric acid, nitric acid, or potassium permanganate, or hydrogen peroxide to form the coal oxide. In some embodiments, mixing the coal with at least one of sulfuric acid, nitric acid, potassium permanganate, or hydrogen peroxide to form the coal oxide can include: mixing the coal with sulfuric acid and then mixing nitric acid with the mixture of coal and sulfuric acid.

In some embodiments, mixing the coal with at least one of sulfuric acid, nitric acid, potassium permanganate, or hydrogen peroxide to form the coal oxide can include stirring the mixture of coal, sulfuric acid, and nitric acid for a predetermined period of time. For example, in some embodiments, the mixture of coal, sulfuric acid, and nitric acid can be stirred for at least about 1 hour, at least about 2 hours, at least about 3 hours, at least about 4 hours, at least about 5 hours, between about 1 hours and about 5 hours, between about 2 hours and about 4 hours, between about 2.5 hours and about 3.5 hours, about 1 hour, about 2 hours, about 3 hours, about 4 hours, about 5 hours, less than about 1 hour, less than about 2 hours, less than about 3 hours, less than about 4 hours, or less than about 5 hours.

In some embodiments, mixing the coal with at least one of sulfuric acid, nitric acid, potassium permanganate, or hydrogen peroxide to form the coal oxide can include, after stirring the mixture of coal, sulfuric acid, and nitric acid, mixing potassium permanganate to the mixture of coal, sulfuric acid, and nitric acid and then stirring the mixture of coal, sulfuric acid, nitric acid, and the potassium permanganate for a predetermined period of time. In some embodiments, the mixture of coal, sulfuric acid, nitric acid, and the potassium permanganate can be stirred on a hot plate heated to between about 25° C. and about 45° C., between about 30° C. and about 40° C., between about 33° C. and about 37° C., at least about 25° C., at least about 30° C., at least about 35° C., at least about 40° C., at least about 45° C. about 25° C., about 30° C., about 35° C., about 40° C., or about 45° C. In some embodiments, the mixture of coal, sulfuric acid, nitric acid, and the potassium permanganate can be stirred for at least about 1 hour, at least about 2 hours, at least about 3 hours, at least about 4 hours, at least about 5 hours, at least about 6 hours between about 1 hours and about 6 hours, between about 3 hours and about 5 hours, between about 3.5 hours and about 4.5 hours, about 1 hour, about 2 hours, about 3 hours, about 4 hours, about 5 hours, about 6 hours, less than about 1 hour, less than about 2 hours, less than about 3 hours, less than about 4 hours, less than about 5 hours, or less than about 6 hours.

In some embodiments, mixing the coal with at least one of sulfuric acid, nitric acid, potassium permanganate, or hydrogen peroxide to form the coal oxide can include diluting the mixture of coal, sulfuric acid, nitric acid, and the potassium permanganate with water to form a solution. The mixture of coal, sulfuric acid, nitric acid, and the potassium permanganate with water at a predetermined mixture: water dilution ratio, such as such as about 1:1, about 1:2, about 1:3, about 1:4, about 1:5, about 1:6, about 1:7, or about 1:8.

In some embodiments, mixing the coal with at least one of sulfuric acid, nitric acid, potassium permanganate, or hydrogen peroxide to form the coal oxide can include mixing the solution, as diluted, with hydrogen peroxide. The hydrogen peroxide can include 10% hydrogen peroxide. Upon mixing the hydrogen peroxide with the solution, the solution turns to a yellow or yellow-green color.

In some embodiments, mixing the coal with at least one of sulfuric acid, nitric acid, potassium permanganate, or hydrogen peroxide to form the coal oxide can include performing a first centrifugation of the solution mixed with the hydrogen peroxide (e.g., in block 230). The solution mixed with hydrogen peroxide can be centrifuged for a predetermined period of time, such as at least about 15 minutes, at least about 30 minutes, at least about 45 minutes, at least about 60 minutes, between about 15 minutes and about 45 minutes, about 15 minutes, about 30 minutes, about 45 minutes, or about 60 minutes. The solution mixed with hydrogen peroxide can be centrifuged at a predetermined revolutions per minute (RPM) that can be dependent on the centrifuge machine. In some embodiments, the solution mixed with hydrogen peroxide can be centrifuged at about 500 RPM.

In some embodiments, mixing the coal with at least one of sulfuric acid, nitric acid, potassium permanganate, or hydrogen peroxide to form the coal oxide can include after performing the first centrifugation (e.g., in block 230), separating supernatant of the solution mixed with the hydrogen peroxide from precipitate of the solution mixed with the hydrogen peroxide (e.g., in block 240). The supernatant includes the coal oxide, and the precipitate can be waste. Once the supernatant has been separated from the precipitate, the supernatant can be diluted with water at a predetermined supernatant: water dilution ratio. For example, the supernatant can be diluted with water at a dilution ratio of 1:0.5, 1:1, 1:1.5, 1:2, 0.5:1, 1.5:1, or 2:1.

At block 230, the coal oxide can be centrifuged during a second centrifugation. The coal oxide that is centrifuged can include the dilution of water and coal oxide described above. The coal oxide and water can be centrifuged for a predetermined period of time, such as at least about 10 minutes, at least about 15 minutes, at least about 20 minutes, at least about 25 minutes, at least about 30 minutes, at least about 35 minutes, at least about 40 minutes, between about 10 minutes and about 40 minutes, between about 15 minutes and about 25 minutes, about 15 minutes, about 20 minutes, about 25 minutes, or about 30 minutes. The coal oxide and water can be centrifuged at a predetermined RPM that can be dependent on the centrifuge machine. In some embodiments, the coal oxide and water can be centrifuged at an RPM that is greater than the RPM of centrifuging of the solution mixed with hydrogen peroxide. For example, the coal oxide and water can be centrifuged at greater than 10,000 RPM, such as about 12,800 RPM.

At block 240, graphene oxide can be collected as precipitate after centrifuging the coal oxide and water, and the supernatant of the centrifugation can be waste. In some cases, block 240 can include sonicating the coal oxide while the coal oxide is in water. In some cases, block 240 can include sonicating graphene oxide that has already been collected as a precipitate.

At block 250, the graphene oxide can be reduced to form reduced graphene oxide. Reducing the graphene oxide removes oxygen containing groups from the graphene oxide and at least partially recovers the electrical conductivity of the graphene. In some embodiments, reducing the graphene oxide to form reduced graphene oxide can include at least sonicating the graphene oxide. The interaction between water and a functional group of the graphene oxide promotes exfoliation of the coal oxide layer. The graphene oxide can be sonicated for a predetermined amount of time, such as at least such as at least about 5 minutes, at least about 10 minutes, at least about 15 minutes, at least about 20 minutes, between about 5 minutes and about 15 minutes, about 5 minutes, about 10 minutes, about 15 minutes, or about 20 minutes. After sonication, the graphene oxide and/or reduced graphene oxide can be analyzed to determine the quality of the graphene oxide and/or reduced graphene oxide using a Raman spectroscopy analysis. The reduced graphene oxide can be formed from coal at a reduced graphene oxide yield rate in a range from about 10 wt % to about 20 wt % of coal, in a range from about 5 wt % to about 25 wt % of coal, in a range from about 15 wt % to about 25 wt % of coal, or in a range from about 5 wt % to about 15 wt % of coal.

In some embodiments, reducing the graphene oxide to form reduced graphene oxide can include hydrothermally treating the graphene oxide in a par reactor after sonicating the graphene oxide. The graphene oxide can be hydrothermally treated in the par reactor for a predetermined amount of time, such as at least about 1 hour, at least about 2 hours, at least about 3 hours, at least about 4 hours, at least about 5 hours, at least about 6 hours between about 1 hours and about 6 hours, between about 3 hours and about 5 hours, between about 3.5 hours and about 4.5 hours, about 1 hour, about 2 hours, about 3 hours, about 4 hours, about 5 hours, about 6 hours, less than about 1 hour, less than about 2 hours, less than about 3 hours, less than about 4 hours, less than about 5 hours, or less than about 6 hours. The graphene oxide can be hydrothermally treated in the par reactor at a predetermined temperature, such as between about 100° C. and about 300° C., between about 130° C. and about 230° C., between about 170° C. and about 190° C., between about 175° C. and about 185° C., at least about 100° C., at least about 140° C., at least about 170° C., at least about 180° C., at least about 190° C., about 170° C., about 175° C., about 180° C., about 185° C., or about 190° C. After the graphene oxide is reduced in the par reactor, the resultant solution is clear with black flakes and chunks. The black flakes and chunks are reduced graphene oxide, which can be confirmed via Raman spectroscopy.

In some examples, naturally occurring coal varieties, without the purifying or refining that is needed to make electronic devices out of silicon, have a range of electrical conductivities that spans seven orders of magnitude (ten million times). As such, a given variety of coal can inherently provide the electrical properties needed for a particular component. For example, Table 1 below shows varying electrical conductivity of coal products.

TABLE 1
Electrical Conductivity of Coal Products

| Product | Electrical Conductivity | | Resistance |
|---|---|---|---|
| Coal + water | 10⁻³ | S/m | 7-20 m Ohm/m |
| Coal at 110° C. + Vacuum | 10⁻⁸ | S/m | 7-20 m Ohm/m |
| Coal Char after pyrolysis to | 10² | S/m | 7-20 m Ohm/m |
| 800° C.+ | | | |
| Coal Pitch (graphitized carbon | 126.6 | S/m | |
| foam) | | | |
| Carbon Fiber - carbonization | 7.58 × 10³ | S/m | 7-20 m Ohm/m |
| at high Temperatures | | | |
| (1,800-2,200° C.) | | | |
| Graphene at Room | 6 × 10⁶ | S/m | |
| Temperature | | | |

In some examples, an energy storage device (e.g., a supercapacitor, a batter, or a fuel cell) can be manufactured by utilizing activated carbon fiber monolith (ACFM) sheet electrodes in a roll-to-roll process. Carbon monoliths are a unitary structure formed from carbon or have a surface including carbon. Such monoliths may have an activated carbon surface and may be a solid structure or have one or more internal channels with high surface area.

Activated carbon monoliths have been manufactured by assembling chopped carbon fibers with a phenolic or polyvinylidene chloride (PVDC) binder. The chopped carbon fibers and the binder undergo various degrees of compression and heat to produce activated carbon monoliths of various densities, structural features, and pore volume properties. The activated carbon monoliths can include, for example, graphite, graphene, hard carbons, or combinations thereof. The activated carbon monoliths can be formed with desired or prescribed densities, pore densities, pore sizes, electrical conductivity, electrical resistivity, and the like. In some examples, the activated carbon monoliths can be formed with varying characteristics, such as densities, through a thickness of the activated carbon monoliths. For example, a density at a first side of an activated carbon monolith can have a first value, a density at a second side of the activated carbon monolith can have a second value different from the first value, and the density can vary throughout the thickness of the activated carbon monoliths, such as in a gradient.

In some examples, the ACFMs can be produced via a coal pitch. The pitch is produced via the distillation of carbon-based materials, such as plants, crude oil, and coal. Pitch is isotropic but can be made anisotropic through the use of heat treatments. In some embodiments, the pitch may be mesophase. Producing the ACFMs or activated carbon monoliths directly from pitch can allow for one or more of the above-described blocks or steps to be omitted.

Mesophase pitch can form a thermotropic crystal, which allows the pitch to become organized and form linear chains without the use of tension. Mesophase pitch is made by polymerizing isotropic pitch to a higher molecular weight. The melting point for the mesophase pitch is roughly 300° C. Melt blowing can be used to form the coal-based pitch into carbon fibers. Melt blowing is a process of fabricating micro- and nanofibers. The coal-based pitch is extruded through small nozzles surrounded by high-speed blowing gas which forms coal based carbon fibers. The carbon fibers may be deposited to form a non-woven fiber mat of randomly oriented carbon fibers. Accordingly, each non-woven fiber mat has melt blown carbon fibers. The non-woven fiber mat may include a number of different properties, such as porosity, average pore diameter, average fiber diameter, Brunauer-Emmett-Teller (BET) surface area, thermal conductivity, and electrical resistance. The non-woven fiber mat can be or include an activated carbon monolith and can be formed as a hard carbon. Depending on process parameters used during the melt blowing process, the non-woven fiber mat can be formed with different thicknesses, pore sizes, porosities, densities, electrical conductivities, electrical resistances, varying densities, and the like.

In some examples, the BET surface area can include a range from less than 5 m²/g to greater than 3000 m²/g. In some examples, the BET surface area can be between 5 m²/g and 100 m²/g, between 100 m²/g and 500 m²/g, between 500 m²/g and 1000 m²/g, between 1000 m²/g and 2000 m²/g, or between 2000 m²/g and 3000 m²/g.

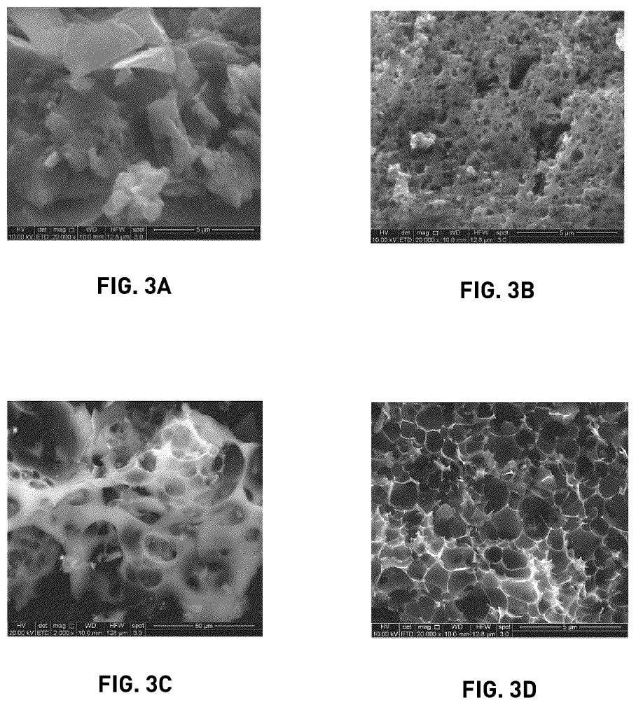

FIGS. 3A-3D show electron microscope images of carbon materials with different structural properties. The carbon materials can include structures with different shapes and characteristics. The carbon materials can be formed with different thicknesses, pore sizes, porosities, densities, electrical conductivities, electrical resistances, varying densities, and the like. As examples, FIGS. 3A and 3D illustrate that the carbon materials can have granular or at least partially spherical shapes. FIGS. 3B and 3C illustrate that the carbon materials can have coral-like or sponge-like shapes.

In some examples, the carbon materials (e.g., the ACFMs) can be calendared in order to obtain rolls or sheets of material having desired densities, electrical properties, and thicknesses. The calendaring can include compressing two sheets of the carbon materials to form a monolith having a desired density for a balance of performance characteristics including: specific capacitance, volumetric capacitance, power level and current density. The calendared monolith can be used as an electrode in an energy storage device, such as a supercapacitor, a battery, a fuel cell, or the like. Calendaring the carbon materials into rolls or sheets can eliminate conventional processes used to form electrodes for various energy storage devices. For example, this process can eliminate expensive electrode slurry paste mixing processes and doctoring of paste onto a carrier. Utilizing the described carbon monoliths could lower the cost or eliminate the carrier film for the electrode as compared to other processes. By utilizing the ACFM sheets, the performance is expected to exceed current particulate activated carbons by more than 100% in specific capacitance at higher power levels.

Activated carbon is one of the most readily available materials that can be used as an electrode, such as in energy storage applications. Carbon is chemically inert to various liquid electrolytes and is stable even at elevated temperatures. The electrical conductivity of carbon, which is completely dependent on its morphology, is an important factor for determining the power density of carbon. The energy density of a capacitor made from activated carbon does not depend much on this morphology. The electronic properties of activated carbon can control the formation of an electric double layer in an electric double layer capacitor (EDLC). Activated carbon is a good material for making electrodes because of its high porosity, good conductivity, thermal stability, and ease of availability. Activated carbon can be a great material for electrodes of supercapacitors or other energy storage devices because of the small pore size, good conductivity, and the large surface area of the carbon. Graphite, graphene, and hard carbons can be good materials for electrodes in energy storage devices (e.g., supercapacitors, batters, and fuel cells) due to their light weight and electrical, thermal, and chemical stability.

In some examples, the ACFM sheets can include composites comprising Group 14 elements, such as silicon, entrained within porous carbon. The silicon-carbon composites may be produced via chemical vapor infiltration to impregnate amorphous, nano-sized silicon within the pores of a porous scaffold. Suitable porous scaffolds include, but are not limited to, porous carbon scaffolds, for example carbon having a pore volume comprising micropores (less than 2 nm), mesopores (2 to 50 nm), and/or macropores (greater than 50 nm). Suitable precursors for the carbon scaffold include, but are not limited to, sugars and polyols, organic acids, phenolic compounds, cross-linkers, and amine compounds. Suitable compositing materials include, but are not limited to, silicon materials.

For various energy storage devices, the electrolyte included between the electrodes can be an important aspect of the capacitor. In traditional capacitors, the dielectric constant of the electrolyte determines the charge storage capacity of the capacitor. Different electrolytes can be used in energy storage devices (e.g., supercapacitors, batters, and fuel cells) of the current disclosure. Based on the selected electrolyte, charging/discharging is possible. There are three things that make supercapacitors, as an example, useful and convenient as compared to conventional capacitors and traditional batteries. These include the energy density, power density, and charge/discharge rate that are achievable with supercapacitors. The type and properties of electrolyte included in a supercapacitor impact these properties of supercapacitors. The electrolyte can generally be characterized in five different categories, depending on: the size and type of ion; the ionic concentration; the collaboration of ions of electrolyte with solvent; charge transfer phenomenon between the electrolyte and the electrode materials; and the potential window. All of these properties have an influence on the EDL capacitance and pseudo-capacitance of an energy storage device. There are various types of electrolytes that can be used, including solid, liquid and quasi-solid-state electrolytes.

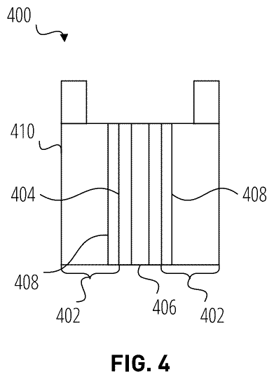

FIG. 4 illustrates an energy storage device 400 including a pair of electrodes 402, an electrolyte 404 between the electrodes 402, and a separator 406 between the electrodes 402. In some examples, the energy storage device 400 of FIG. 4 may be a charcoal-based capacitor, and the electrodes 402 can include, for example, charcoal-based, carbon-based, hard carbon, graphite, or graphene electrode materials 408. The energy storage device 400 can be any type of energy storage device described herein, such as a supercapacitor, a battery, or a fuel cell.

The electrodes 402 can include plates 410 (e.g., formed from aluminum or another conductive material) that function as a collector. The electrodes 402 can include activated charcoal that is used as the electrode material 408. The electrodes 402 can include polyurethane, which can be used as a binder between the electrode materials 408 and the plates 410. Any of the ACFMs or carbon materials described herein can be used for the electrode materials 408. The separator 406 can play an important role in the energy storage device 400, such as preventing the contact between the two electrodes 402 and allowing charge to flow from one electrode 402 to the other electrode 402. In some examples, the electrolyte 404 can include phosphoric acid, which is one of the best acids for conduction. Other electrolytes, such as sulfuric acid, potassium hydroxide, or the like, can also be used for the electrolyte 404. The construction diagram is shown in FIG. 4.

In the example of FIG. 4, activated carbon can be used as the electrode material 408 for the electrodes 402. Activated carbon has a high surface area and a large capacitance value. The electrical conductivity of the carbon is around 0.003% that of metal. Activated charcoal is a porous form of carbon that gives the material an extremely high specific surface area. Energy storage devices 400 (e.g., supercapacitors, batteries, or fuel cells) can be fabricated with electrode materials (e.g., for the electrodes 402) such as carbon, charcoal, metal oxides, graphite, graphene, hard carbons, and the like and the described electrolytes 404. The energy storage device 400 can have, for example, reduced weight, reduced cost, and improved electrical characteristics (e.g., improved energy/power storage and improved charge/discharge rates).

In some examples, a porous carbon is used as the electrode material 408 for the electrodes 402. The source of the porous carbon can be acid washed activated charcoal. Activated charcoal can be used as the electrode material 408. Stainless steel mesh can be used as a current collector in the electrochemical capacitor (e.g., for the plates 410). The mesh provides a high surface area to store the charges. Suitable electrolyte (e.g., 10% of NaOH) can be added to the electrodes 402. Capacitance can be approximately equal to 1.14 farad.

In some examples, the electrode material 408 can have a varying density or varying functionalization through a thickness of the electrode material 408. For example, the electrode material 408 can have higher ionic conductivity towards the separator 406 and higher electrical conductivity towards the plate 410. This can help to improve performance of the energy storage device 400. The density or functionalization gradient can be applied to various energy storage devices, including potassium air batteries, other batteries, fuel cells, and other energy storage devices, in addition to supercapacitors. In some examples, functionalization or densities of the electrode material 408 can vary through the thickness of the electrode material 408, which can drive ionic conductivity and specificity of complexed metal ions. The complexed metal ions can be complexed in the electrode material 408 as functionalization chemistry. The variation of functionalization or densities of the electrode material 408 through the thickness of the electrode material 408 can optimize mass transport and electrical conductivity of the electrode material 408.

The electrode material 408 can be an activated carbon monolith, which can be an interconnected fibrous network. The electrode material 408 can be formed by stacking two or more carbon layers (e.g., layers of graphite, graphene, or hard carbons) and compressing the carbon layers such that the carbon layers exhibit a desired density, pore density, and electrical characteristics. Various characteristics of the fibers in the ACFM monolith can be altered to optimize the electrode material 408, including the diameter of the fibers, the distances between nodes, the degree of fusion between filaments, and the like.

The electrode material 408 can include various impurity atoms that are present in a raw material used to form the electrode material 408. For example, the electrode material 408 can include any of cadmium, selenium, boron, nitrogen, and/or silicon. A concentration of the impurity atoms in the electrode material 408 (e.g., in a carbon monolith) can be in a range from 0.1 atomic % to 10 atomic %. The impurity atoms can be included in a raw material used to form the electrode material 408 in a concentration at least as high as the electrode material 408.

The active material used in a supercapacitor (or other energy storage device) determines the capacitance of the device. Materials make up 71% of the cost to manufacture a capacitor or other energy storage device. Of this percentage, the most significant cost component is the active material. Graphene is a highly conductive material derived from a single layer of graphite that increases the surface area of the electrode and hence the capacitance. In some examples, graphene quantum dots can be added to the material. The graphene quantum dots can raise the specific capacitance of the carbon to between 300 farads/gm² and 400 farads/gm². In some examples, the specific capacitance can be about 388 farads/gm². The quantum dots provide a greater conductivity to the graphene due to the sp2 orbitals. Because the conductivity is raised, the capacitance is raised. Hard carbons and other carbon-based materials can also be produced with low cost through the disclosed methods, and can have high surface areas, high capacitances, and make improved energy storage devices.

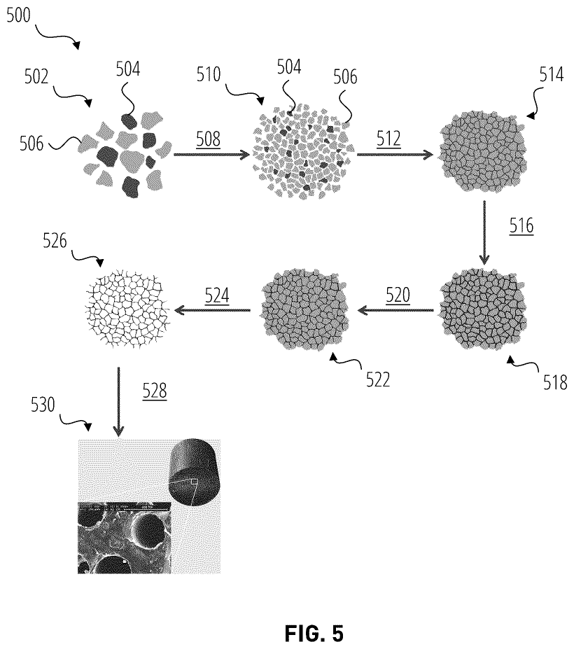

FIG. 5 illustrates a method 500 for producing a carbon material, carbon product, or activated carbon fiber monolith, such as graphene (e.g., 3D graphene). The method 500 can include catalytic graphenization. Referring to FIG. 5, one challenge with using graphene in practical energy storage devices (e.g., supercapacitors, batteries, or fuel cells) is that fully exfoliated graphene sheets restack, and form aggregated graphite-like powders or films due to strong sheet-to-sheet van der Waals interactions. This decreases surface area and reduces ion diffusion rates, resulting in unsatisfactory capacitances and poor rate performance. One way to address this challenge is to construct the 2D graphene sheets into a well-organized and interconnected, porous, 3D structures, such as an ACFM. This prevents sheet restacking and preserves the electrical properties, while enabling a large accessible internal surface area, efficient mass transport, and high electron conduction.

In the method 500, a solid mixture 502 can be formed by supplying a raw material 504 (e.g., a coal tar pitch (CTP)) and a catalyst 506 (e.g., a reagent such as potassium carbonate (K₂CO₃)). The raw material 504 can include a mixture of various hydrocarbons. The raw material 504 and the catalyst 506 can be supplied with a mass ratio of 1:10. A process 508 can be performed on the solid mixture 502 to homogeneously disperse the raw material 504 and the catalyst 506. The process 508 can include ball milling or grinding. The process 508 can be performed for a period of about 10 minutes, about 15 minutes, about 20 minutes, in a range from about 10 minutes to about 20 minutes, or the like. The process 508 can produce a crushed solid mixture 510, which includes the raw material 504 and the catalyst 506 with the mass ratio of 1:10.

This crushed solid mixture 510 is then heated by a process 512 to a temperature greater than a melting point of the raw material 504. For coal tar pitch, the process 512 can heat the crushed solid mixture 510 to a temperature greater than about 110° C. This can which convert the raw material 504 (e.g., the CTP) into a liquid that can coat particles of the catalyst 506 (e.g., K₂CO₃) and infiltrate spaces between the particles of the catalyst 506. The resulting material 514 can then be further heated by a process 516 to carbonize the material 514 into a carbonized material 518. The process 516 can heat the material 514 to a temperature of about 600° C. under a nitrogen atmosphere. The process 516 can have a duration of about 2 hours, about 1.5 hours, about 2.5 hours, in a range from about 1 hour to about 3 hours, or in a range from about 1.5 hours to about 2.5 hours. The process 516 can cause the formation of an interconnected 3D network of carbon nanosheets. This can be evidenced by SEM and Raman characterization.

The carbonized material 518 can then be further heated in a process 520 to catalytically convert the carbon nanosheets of the carbonized material 518 into a graphene material 522. The process 520 can heat the carbonized material 518 to a temperature in a range from about 900° C. to about 1000° C. The process 520 can heat the carbonized material 518 under a nitrogen atmosphere. The process 520 can have a duration of about 1 hour, about 1.5 hours, about 2 hours, in a range from about 0.5 hours to about 2.5 hours, or in a range from about 1 hour to about 2 hours. The graphene material 522 can include graphene nanosheets.

A process 524 can then be formed on the graphene material 522 to form a 3D graphene material 526. The process 524 can include rinsing the catalyst 506 (e.g., K₂CO₃) from the graphene material of the graphene material 522. Variations can be made to the method 500 in order to alter characteristics of the material or product produced by the method 500. For example, using longer graphenization times can cause a dramatic reduction in the carbon yield and surface area of the sample. Additionally, using CTP:K₂CO₃ mass ratios that are below 1:10 still results in microscopic 3D graphitic porous carbons, whereas using a higher mass ratio leads to lower production yield. This network possesses irregularly shaped, macro- and meso-scale pore structures with sizes ranging from a few microns down to tens of nanometers. Finally, a process 528 can be performed on the 3D graphene material 526 to compress the 3D graphene material 526 into a carbon monolith 530.

Further, the variation of graphene layers with synthesis temperature can be explained by the molten catalyst 506 (e.g., K₂CO₃) viscosity. At 900° C., which is slightly above the K₂CO₃ melting point (891° C.), the molten salt has a higher viscosity. This limits the movement of graphene sheets that are formed, as well as their restacking to generate thicker microstructures. However, at higher temperatures, the lower viscosity of the molten salt allows graphene sheets that are formed to move more freely, leading to additional restacking which increases the number of graphene sheets observed in the microstructure.

As used herein, the term “about” or “substantially” refers to an allowable variance of the term modified by “about” or “substantially” by +10% or +5%. Further, the terms “less than,” “or less,” “greater than,” “more than,” or “or more” include, as an endpoint, the value that is modified by the terms “less than,” “or less,” “greater than,” “more than,” or “or more.”

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Various embodiments have been described herein with reference to certain specific examples. However, they will be recognized by those skilled in the art that many variations are possible without departing from the scope and spirit of the embodiments disclosed herein, in that those embodiments set forth in the claims below are intended to cover all variations and modifications of the disclosure without departing from the spirit of the embodiments.

What is claimed is:

1. A method of producing an energy storage device, the method comprising:
treating pitch to produce a carbon fiber material;
fusing a plurality of carbon fibers of the carbon fiber material together to form a carbon monolith, wherein the plurality of carbon fibers are fused at contact points by melt blowing; and
compressing the carbon monolith to a predetermined density.

2. The method of claim 1, further comprising:
beneficiating coal comprising impurity atoms to remove a predetermined amount of the impurity atoms; and
processing the beneficiated coal to produce the pitch.

3. The method of claim 2, wherein the coal comprises impurity atoms, the impurity atoms comprising at least one of cadmium, selenium, boron, nitrogen, or silicon.

4. The method of claim 1, wherein the pitch comprises mesophase pitch.

5. The method of claim 1, wherein the compressed carbon monolith has a specific surface area in a range from 5 m²/g to 3000 m²/g.

6. The method of claim 1, further comprising manufacturing an energy storage device using the compressed carbon fiber monolith in a roll-to-roll process.

7. The method of claim 1, wherein the carbon monolith comprises impurity atoms comprising at least one of cadmium, selenium, boron, nitrogen, or silicon.

8. The method of claim 7, wherein a concentration of the impurity atoms in the carbon monolith is in a range from 0.1 atomic % to 10 atomic %.

9. An energy storage device formed from coal, the energy storage device comprising:
an electrode comprising:
a first activated carbon fiber monolith; and
a second activated carbon fiber monolith compressed with the first activated carbon fiber monolith, wherein the electrode exhibits predetermined performance characteristics.

10. The energy storage device of claim 9, wherein the predetermined performance characteristics comprise at least one of specific capacitance, volumetric capacitance, power level, or current density.

11. The energy storage device of claim 9, wherein the first activated carbon monolith has a porosity or density different from the second activated carbon monolith.

12. A method of producing a carbon-based energy storage device from coal, the method comprising:
thermally processing coal at a temperature of at least 300° F.;
at least partially cooling the coal;
forming a reduced graphene oxide from the coal; and
forming an energy storage device from the reduced graphene oxide.

13. The method of claim 12, wherein forming the reduced graphene oxide from the coal comprises:
oxidizing the coal to form a coal oxide;
centrifuging the coal oxide;
collecting a precipitate from the coal oxide, the precipitate comprising graphene oxide; and
reducing the graphene oxide to form the reduced graphene oxide.

14. The method of claim 13, wherein oxidizing the coal to form the coal oxide comprises mixing the coal with at least one of sulfuric acid, nitric acid, or potassium permanganate, or hydrogen peroxide to form the coal oxide.

15. The method of claim 14, wherein mixing the coal with at least one of sulfuric acid, nitric acid, potassium permanganate, or hydrogen peroxide to form the coal oxide comprises:
mixing the coal with at least one of sulfuric acid or nitric acid to form a first coal mixture;
stirring the first coal mixture;
mixing potassium permanganate with the first coal mixture to form a second coal mixture;
stirring the second coal mixture;
diluting the second coal mixture with water to form a first solution;
mixing the solution with hydrogen peroxide to form a second solution;
performing a first centrifugation on the second solution; and
after performing the first centrifugation, separating a supernatant of the second solution from a precipitate of the second solution, the supernatant comprising the coal oxide.

16. The method of claim 13, further comprising diluting the coal oxide with water before centrifuging the coal oxide.

17. The method of claim 13, wherein reducing the graphene oxide to form reduced graphene oxide comprises:
sonicating the graphene oxide; and
hydrothermally treating the graphene oxide in a par reactor after sonicating the graphene oxide.

18. The method of claim 12, wherein the thermally processing the coal at the temperature of at least about 300° F. comprises:
heating the coal to a first temperature of less than 350° F.;
transferring the coal to a mercury removal reactor;
heating the coal in the mercury removal reactor to a second temperature of at least 500° F.; and
contacting the coal with an inert gas to remove at least a portion of mercury present in the coal.

19. The method of claim 12, wherein the reduced graphene oxide comprises a predetermined amount of impurity atoms present in the coal.

20. The method of claim 19, wherein the impurity atoms comprise at least one of boron, nitrogen, or silicon.
